(19) United States
(12) Patent Application Publication
(10) Pub. No.: US 2022/0032707 A1
(43) Pub. Date: Feb. 3, 2022

(54) SUSPENSION SYSTEM

(71) Applicant: Hitachi Astemo, Ltd., Ibaraki (JP)

(72) Inventors: Yuki YOSHIDA, Atsugi-shi, Kanagawa (JP); Masatoshi YAMAHATA, Chigasaki-shi, Kanagawa (JP)

(21) Appl. No.: 17/277,453

(22) PCT Filed: Sep. 18, 2019
(86) PCT No.: PCT/JP2019/036503

§ 371 Date: Mar. 18, 2021

(30) Foreign Application Priority Data
Oct. 25, 2018 (JP) 2018-201026

(51) Int. Cl. B60G 17/015; B60G 17/017; B60G 17/019

(52) U.S. Cl. CPC B60G 17/0155; B60G 17/017; B60G 17/019; B60G 2800/914; B60G 2400/252; B60G 2500/30; B60G 2202/152

(57) ABSTRACT

A stopped vehicle height of an air suspension for a stop-side wheel on a side that stops first is determined in consideration of a vehicle height that changes in accordance with a vehicle height change of the air suspension for a supply/discharge-side wheel on another side after a stop. Thus, when vehicle height adjustment of the air suspension for the supply/discharge-side wheel is finished, the stopped vehicle height of the air suspension for the stop-side wheel can be adjusted to the vicinity of a target value and the precision in the vehicle height adjustment can be increased.

### TECHNICAL FIELD

The present invention relates to a suspension system which is to be installed to a vehicle, such as a four-wheeled vehicle, and is configured to perform vehicle height adjustment by controlling supply and discharge of compressed air to and from an air suspension for each wheel.

### BACKGROUND ART

In Patent Literature 1, there is disclosed a suspension system that is configured to perform vehicle height adjustment by controlling supply and discharge of compressed air to and from an air suspension provided for each wheel.

### CITATION LIST

### Patent Literature

PTL 1: JP 10-309919 A

### SUMMARY OF INVENTION

### Technical Problem

In the suspension system as disclosed in Patent Literature 1, for example, when an unbalanced load acts thereon, vehicle height adjustment of the air suspension for the left rear wheel and vehicle height adjustment of the air suspension for the right rear wheel are simultaneously started. When the vehicle height adjustment of the air suspension for the left rear wheel is finished first, the vehicle height of the air suspension for the left rear wheel (stop-side wheel) for which the supply and discharge of the compressed air are stopped may be changed through drag by the change in vehicle height of the air suspension for the right rear wheel (supply/discharge-side wheel) for which the supply and discharge of the compressed air continues. The above-mentioned passive vehicle height change of the air suspension for the stop-side wheel induces a decrease in precision in the vehicle height adjustment and an occurrence of hunting (fluttering of an opening and closing operation of a supply/discharge control valve) due to an excess of the vehicle height beyond an allowable range of a target value.

### Solution to Problem

The present invention has an object to increase precision in vehicle height adjustment of a suspension system.

According to one embodiment of the present invention, there is provided a suspension system, including: a right-side suspension and a left-side suspension interposed between a vehicle body and an axle, each of the right-side suspension and the left-side suspension being provided on at least one of a front side and a rear side so as to be capable of adjusting a vehicle height in accordance with supply and discharge of working fluid; a supply/discharge mechanism configured to supply and discharge the working fluid to and from each of the right-side suspension and the left-side suspension; and a vehicle height detector configured to detect or estimate the vehicle height of each of the right-side suspension and the left-side suspension, wherein when vehicle height adjustment of each of the right-side suspension and the left-side suspension is performed through use of the supply/discharge mechanism so that a detection value of the vehicle height detector approaches a target vehicle height, a stopped vehicle height of a suspension on one side, which is one of the right-side suspension and the left-side suspension, and stops first, is determined in consideration of a vehicle height changed in accordance with a change in vehicle height of a suspension on another side after the stop.

According to one embodiment of the present invention, precision in vehicle height adjustment of a suspension system can be increased.

### BRIEF DESCRIPTION OF DRAWINGS

FIG. 1 is a pneumatic circuit diagram for illustrating a vehicle height adjustment mechanism according to an embodiment of the present invention.

FIG. 2 is a graph for showing processing by a controller when vehicle height adjustment of an air suspension is solely performed.

FIG. 3 is a graph for showing processing for the vehicle height adjustment by a controller of a related-art suspension system.

FIG. 4 is a graph for showing the processing for the vehicle height adjustment by the controller of a suspension system according to the embodiment.

### DESCRIPTION OF EMBODIMENTS

One embodiment of the present invention is described below with reference to the drawings.

Description is now given of a case in which a suspension system 1 is applied to a four-wheeled vehicle (vehicle). The suspension system 1 includes air suspensions and supply/discharge control valves. The air suspensions are provided for respective left and right front wheels and left and right rear wheels of the vehicle. The supply/discharge control valves are each configured to control supply and discharge of compressed air (supply and discharge of working fluid) to and from corresponding one of the air suspensions. A vehicle height adjustment mechanism in the suspension system 1 has the same basic structures for the front side and the rear side of the vehicle, and description is therefore given of air suspensions for the left and right wheels on the rear side of the vehicle.

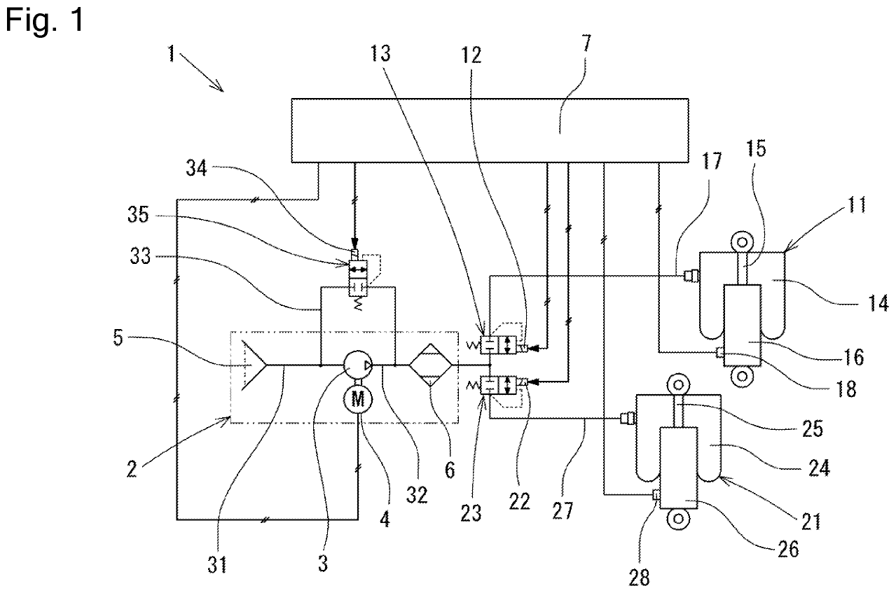

Referring to FIG. 1, the suspension system 1 includes an air suspension 11 (suspension on one side), an air suspension 21 (suspension on another side), and a compressor 2. The air suspension 11 is interposed between a vehicle body (not shown) and the left rear wheel (not shown). The air suspension 21 is interposed between the vehicle body and the right rear wheel (not shown). The compressor 2 is a source for generating compressed air to be supplied to each of the air suspensions 11 and 21. The air suspensions 11 and 21 of the suspension system 1 are not limited to air suspensions, and may be hydraulic cylinders. The compressor 2 includes a pump 3, an electric motor 4, a suction filter 5, and a dryer 6. The electric motor 4 drives the pump 3. The suction filter 5 is arranged in a suction pipe 31. The dryer 6 is arranged in a feed pipe 32. The dryer 6 adsorbs a moisture content of the compressed air fed from the pump 3, and is regenerated by passage of the compressed air discharged from the air suspensions 11 and 21. The compressor 2 may be of any type, such as a reciprocating type, a scroll type, or a linear type.

The air suspensions 11 and 21 include air springs 14 and 24 and hydraulic shock absorbers 16 and 26, respectively. The air springs 14 and 24 are extended and contracted by the supply and the discharge of the compressed air. The hydraulic shock absorbers 16 and 26 generate damping forces as piston rods 15 and 25 extend and contract, respectively. The air suspensions 11 and 21 are connected to the feed pipe 32 of the compressor 2 through intermediation of supply/discharge pipes 17 and 27, respectively. In the supply/discharge pipes 17 and 27, supply/discharge control valves 13 and 23 driven by solenoids 12 and 22 are arranged, respectively. For the air suspensions 11 and 21, vehicle height sensors 18 and 28 (vehicle height detectors) configured to detect vehicle heights HL and HR are provided, respectively. The suspension system 1 excluding the air suspensions 11 and 21 forms a supply/discharge mechanism.

The suspension system 1 includes a bypass pipe 33 configured to bypass between the suction pipe 31 and the feed pipe 32 of the compressor 2. The bypass pipe 33 is provided so as to bypass the pump 3 of the compressor 2. In the bypass pipe 33, there is provided a discharge valve 35 driven by a solenoid 34. In the suspension system 1, when the discharge valve 35 and the supply/discharge control valves 13 and 23 are opened, the compressed air discharged from the air springs 14 and 24 of the air suspensions 11 and 21 is discharged to the atmosphere through the dryer 6, the bypass pipe 33, and the suction pipe 31.

The suspension system 1 includes a controller 7 formed of, for example, a microcomputer. The electric motor 4, the solenoids 12 and 22 of the supply/discharge control valves 13 and 23, the solenoid 34 of the discharge valve 35, and the vehicle height sensors 18 and 28 are connected to the controller 7 through cables.

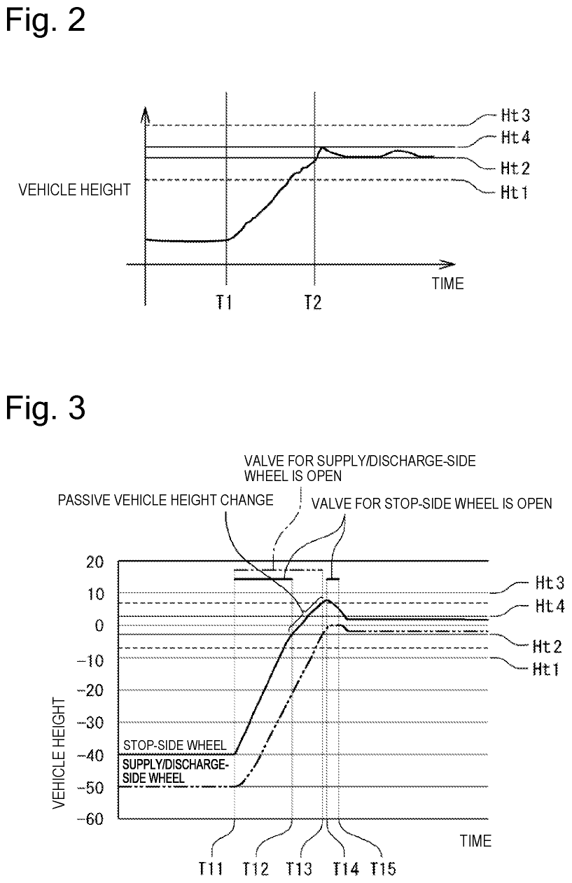

With reference to FIG. 2, description is now given of processing by the controller 7 at the time when the vehicle height of the air suspension 11 for the left rear wheel is to be solely adjusted.

When it is detected that the vehicle height HL of the air suspension 11 is lower than a supply-side vehicle height adjustment start threshold value Ht1 (HL<Ht1) at a time T1, the controller 7 opens the supply/discharge control valve 13 to supply the compressed air to the air spring 14 (start of vehicle height adjustment). As a result, the air spring 14 extends, and the vehicle height HL of the air suspension 11 thus increases. After that, when it is detected that the vehicle height HL of the air suspension 11 has reached a supply-side vehicle height adjustment end threshold value Ht2 (HL=Ht2) at a time T2, the controller 7 closes the supply/discharge control valve 13 to stop the supply of the compressed air to the air spring 14 (end of vehicle height adjustment). As a result, the vehicle height HL of the air suspension 11 is adjusted to a vicinity of a target value (HL=0 mm).

With reference to FIG. 3, a description is now given of processing for the vehicle height adjustment by a controller (7) of a related-art suspension system (1) for comparison with the suspension system 1.

In this case, a load larger than that on the air suspension 11 for the left rear wheel acts on the air suspension 21 for the right rear wheel. The vehicle height HR of the air suspension 21 for the right rear wheel at the start of the vehicle height adjustment at a time T11 is lower than the air suspension 11 for the left rear wheel at the time T11. Referring to FIG. 3, the vehicle height HR of the air suspension 21 for the right rear wheel at the start of the vehicle height adjustment at the time T11 is −50 mm while the vehicle height HL of the air suspension 11 for the left rear wheel at the time T11 is −40 mm.

When it is detected that the vehicle heights HL and HR are lower than the supply-side vehicle height adjustment start threshold value Ht1 at a time T11, the controller opens the supply/discharge control valves 13 and 23 to supply the compressed air to the air springs 14 and 24 (start of vehicle height adjustment). As a result, the air springs 14 and 24 extend, and the vehicle heights HL and HR of the air suspensions 11 and 21 thus increase.

After that, when it is detected that the vehicle height HL of the air suspension 11 for the left rear wheel has reached the supply-side vehicle height adjustment end threshold value Ht2 (HL=Ht2) at a time T12, the controller closes the supply/discharge control valve 13 to stop the supply of the compressed air to the air spring 14 (end of vehicle height adjustment). Meanwhile, the vehicle height HR of the air suspension 21 for the right rear wheel has not reached the supply-side vehicle height adjustment end threshold value Ht2 at the time T12, and the controller thus maintains the open state of the supply/discharge control valve 23. As a result, the vehicle height HR of the air suspension 21 for the right rear wheel continues to increase after the vehicle height HL of the air suspension 11 for the left rear wheel stops.

Of the wheels arranged on the left side and right side of the vehicle, the wheel for which the vehicle height adjustment of the air suspension is finished first, and the supply of the compressed air to the air spring for which is thus stopped is hereinafter referred to as “stop-side wheel,” and the wheel on an opposite side of the stop-side wheel, that is, the wheel for which the supply of the compressed air to the air suspension is continued after the supply of the compressed air to the air suspension for the stop-side wheel is stopped is referred to as “supply/discharge-side wheel.”

When it is detected that the vehicle height HR of the air suspension 21 for the right rear wheel has reached the supply-side vehicle height adjustment end threshold value Ht2 (HR=Ht2) at a time T13, the controller closes the supply/discharge control valve 23 to stop the supply of the compressed air to the air spring 24 (end of vehicle height adjustment). In the related-art suspension system, in a period from the time T12 to the time T13, which is a period from the end of the vehicle height adjustment of the air suspension 11 for the left rear wheel to the end of the vehicle height adjustment of the air suspension 21 for the right rear wheel, that is, the period from the end of the vehicle height adjustment of the suspension for the stop-side wheel to the end of the vehicle height adjustment of the suspension for the supply/discharge-side wheel, the vehicle height HL of the air suspension 11 for the left rear wheel (stop-side wheel) continues to increase at a substantially constant rate (speed) in such a manner that the vehicle height HL is dragged by the increase of the vehicle height HR of the air suspension 21 for the right rear wheel (supply/discharge-side wheel) even under the state in which the controller stops the supply of the compressed air to the air spring 14.

After that, when it is detected that the vehicle height HL of the air suspension 11 for the left rear wheel (stop-side wheel) exceeds a discharge-side vehicle height adjustment start threshold value Ht3 (HL>Ht3), the controller opens the supply/discharge control valve 13 and the discharge valve 35. As a result, the compressed air in the air spring 14 is discharged to the atmosphere, and the vehicle height HL of the air suspension 11 for the left rear wheel decreases. After that, when it is detected that the vehicle height HL of the air suspension 11 for the left rear wheel has reached a discharge-side vehicle height adjustment end threshold value Ht4 (HL=Ht4), the controller closes the supply/discharge control valve 13 and the discharge valve 35, and finishes the vehicle height adjustment for the left rear wheel.

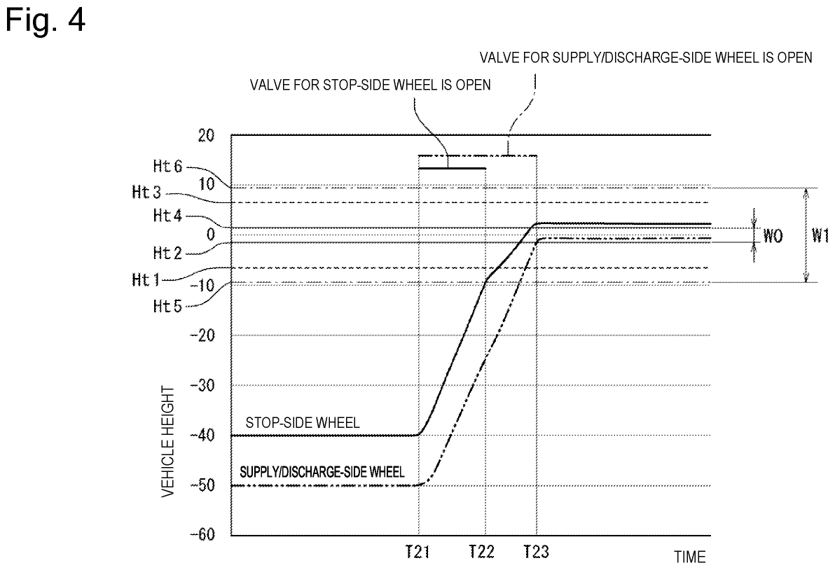

With reference to FIG. 4, a description is now given of processing for the vehicle height adjustment by the controller 7 of the suspension system 1.

In the suspension system 1, the stop time of the change in vehicle height of the suspension on one side for the stop-side wheel is set to be earlier by an amount corresponding to the influence of the change in vehicle height of the suspension on another side for the supply/discharge-side wheel on the vehicle height of the suspension on the one side for the stop-side wheel, that is, an amount of a passive change in vehicle height.

Similarly to the related-art suspension system described above, a load larger than that on the air suspension 11 for the left rear wheel (stop-side wheel) acts on the air suspension 21 for the right rear wheel (supply/discharge-side wheel). Referring to FIG. 4, the vehicle height HR of the air suspension 21 for the right rear wheel at the start of the vehicle height adjustment at a time T21 is −50 mm while the vehicle height HL of the air suspension 11 for the left rear wheel at the time T21 is −40 mm.

When it is detected that the vehicle heights HL and HR are lower than the supply-side vehicle height adjustment start threshold value Ht1 at the time T21, the controller 7 compares the vehicle height HL of the air suspension 11 for the left rear wheel obtained from a detection signal of the vehicle height sensor 18 and the vehicle height HR of the air suspension 21 for the right rear wheel obtained from a detection signal of the vehicle height sensor 28 with each other. The controller 7 recognizes the wheel on the side on which the vehicle height reaches the supply-side vehicle height adjustment end threshold value Ht2 as the stop-side wheel, and recognizes the wheel on the opposite side as the supply/discharge-side wheel.

After that, the controller 7 calculates a correction value Ld for the vehicle height adjustment end threshold value for the air suspension 11 for the left rear wheel (stop-side wheel) based on Expression 1.

Ld=|HL−HR|·G Expression 1

HL given in Expression 1 is the vehicle height of the suspension for the stop-side wheel (air suspension 11 for the left rear wheel) at the start of the vehicle height adjustment. HR is the vehicle height of the suspension for the supply/discharge-side wheel (air suspension 21 for the right rear wheel) at the start of the vehicle height adjustment. |HL−HR| is a difference between the vehicle height of the suspension for the stop-side wheel and the vehicle height of the suspension for the supply/discharge-side wheel.

Moreover, G given in Expression 1 is a ratio (hereinafter referred to as “speed ratio G”) of the vehicle height change rate (vehicle height change speed) of the passive vehicle height change of the suspension for the stop-side wheel (in this case, the air suspension 11 for the left rear wheel) to the vehicle height change rate (vehicle height change speed) of the suspension for the supply/discharge-side wheel (in this case, the air suspension 21 for the right rear wheel). That is, the speed ratio G is given as follows.

Speed ratio G=(passive vehicle height change speed corresponding to stop-side wheel)/(vehicle height change speed corresponding to supply/discharge-side wheel)

The speed ratio G may be determined through not only the vehicle height change rates, but also change rates of internal pressures of the air springs 14 and 24.

The speed ratio G is determined based on actually measured values for each of left and right front wheels and the left and right rear wheels, and is stored in, for example, a lookup table in a memory of the controller 7. A vehicle height adjustment end width W1 (one side of the width is a supply-side vehicle height adjustment end threshold value Ht5 and another side is a discharge-side vehicle height adjustment end threshold value Ht6) after correction for the suspension for the stop-side wheel (air suspension 11 for the left rear wheel) is determined by adding the correction value Ld to a standard vehicle height adjustment end width W0 (one side of the width is the supply-side vehicle height adjustment end threshold value Ht2 and another side is the discharge-side vehicle height adjustment end threshold value Ht4) before the correction. That is, the vehicle height adjustment end width W1 is given as follows.

(Vehicle height adjustment end width W1 corresponding to stop-side wheel)=(standard vehicle height adjustment end width W0)+(correction value Ld)

The controller 7 uses the correction value Ld to correct the vehicle height adjustment end width of the air suspension 11 for the left rear wheel (stop-side wheel), and opens the supply/discharge control valves 13 and 23, to thereby supply the compressed air to the air springs 14 and 24 (start of the vehicle height adjustment). As a result, the air springs 14 and 24 extend, and the vehicle heights HL and HR of the air suspensions 11 and 21 consequently increase. The vehicle height adjustment end width for the air suspension 21 for the right rear wheel (supply/discharge-side wheel) is the standard vehicle height adjustment end width.

When it is detected that the vehicle height HL of the air suspension 11 for the left rear wheel (stop-side wheel) has reached the supply-side vehicle height adjustment end threshold value Ht5 after the correction (HL=Ht5) at a time T22, the controller 7 closes the supply/discharge control valve 13, to thereby stop the supply of the compressed air to the air spring 14 (end of vehicle height adjustment for the stop-side wheel). Meanwhile, the vehicle height HR of the air suspension 21 for the right rear wheel (supply/discharge-side wheel) has not reached the supply-side vehicle height adjustment end threshold value Ht2 at the time T22, and the controller 7 thus maintains the open state of the supply/discharge control valve 23. As a result, the vehicle height HR of the air suspension 21 for the right rear wheel continues to increase after the vehicle height adjustment of the air suspension 11 for the left rear wheel stops.

When it is detected that the vehicle height HR of the air suspension 21 for the right rear wheel (supply/discharge-side wheel) has reached the supply-side vehicle height adjustment end threshold value Ht2 (HR=Ht2) at a time T23, the controller 7 closes the supply/discharge control valve 23, to thereby stop the supply of the compressed air to the air spring 24 (end of vehicle height adjustment for the supply/discharge-side wheel). As a result, the vehicle height HR of the air suspension 21 for the right rear wheel is adjusted to a vicinity of a target value (HR=0 mm).

In the suspension system, the vehicle height HL of the air suspension 11 for the left rear wheel (stop-side wheel) passively increases while following the vehicle height change of the air suspension 21 for the right rear wheel (supply/discharge-side wheel) after the end of the vehicle height adjustment for the stop-side wheel at the time T22, and is adjusted to a vicinity of the target value (HL=0 mm) when the vehicle height adjustment for the supply/discharge-side wheel is finished at a time T33.

As described above, in the related-art suspension system, the vehicle height of the suspension for the stop-side wheel passively changes while following the vehicle height change of the suspension for the supply/discharge-side wheel after the vehicle height adjustment of the suspension for the stop-side wheel is finished, and there thus arise problems such as a decrease in precision in the vehicle height adjustment and an occurrence of hunting (fluttering of the opening/closing operation of the supply/discharge control valves).

Meanwhile, in the suspension system 1, the stopped vehicle height (vehicle height adjustment end threshold value) of the air suspension 11 (suspension on the one side) for the stop-side wheel on the one side that stops first is determined in consideration of the vehicle height that changes in accordance with the vehicle height change of the air suspension 21 (suspension on the another side) for the supply/discharge-side wheel on the another side after the stop, that is, determined in consideration of the passive vehicle height change after the end of the vehicle height adjustment. Thus, when the vehicle height adjustment of the air suspension 21 for the supply/discharge-side wheel is finished, the stopped vehicle height of the air suspension 11 for the stop-side wheel can be adjusted to the vicinity of the target value.

According to this embodiment, the following effects are provided.

According to this embodiment, a suspension system includes a suspension on one side and a suspension on another side, which are interposed between a vehicle body and axles, are provided for a left wheel and a right wheel on at least one of a front side and a rear side, and are configured to adjust vehicle heights in accordance with supply and discharge of working fluid, a pressurization device configured to pressurize the working fluid, and a vehicle height detector configured to detect or estimate the vehicle height of each suspension. When each suspension is driven such that a detection value of the vehicle height detector approaches a target vehicle height, a stopped vehicle height of a suspension, which is of the suspension on the one side and the suspension on the another side, and stops first, is determined in consideration of a vehicle height that changes in accordance with a vehicle height change of the suspension on the another side after the stop. That is, the stopped vehicle height is determined in consideration of the passive vehicle height change caused by the vehicle height change in the suspension on the another side. As a result, the stopped vehicle height of the suspension that stops first can be adjusted to a vicinity of the target vehicle height.

Consequently, precision in the vehicle height adjustment to be performed under an unbalanced load or on a rough terrain can be increased.

Moreover, there is a difference in vehicle height between the suspension on the one side and the suspension on the another side even on a paved road surface, and the precision in the vehicle height adjustment can be increased also in an ordinary vehicle height adjustment on the paved road surface.

Further, the vehicle height of the suspension that stops first does not again exceed a vehicle height adjustment start threshold value even when the passive vehicle height change of the suspension that has stopped first occurs, and it is thus possible to prevent the hunting from occurring in the vicinity of the vehicle height adjustment start threshold value.

The embodiment is not limited to the above-mentioned example, and, for example, may be configured as described below.

The pneumatic circuit for the vehicle height adjustment is an open circuit that releases the compressed air discharged from the air springs 14 and 24 to the atmosphere in this embodiment, but may be a closed circuit that accumulates the compressed air discharged from the air springs 14 and 24 in an accumulator.

Note that, the present invention is not limited to the embodiment described above, and includes further various modification examples. For example, in the embodiment described above, the configurations are described in detail in order to clearly describe the present invention, but the present invention is not necessarily limited to an embodiment that includes all the configurations that have been described. Further, a part of the configuration of a given embodiment can replace the configuration of another embodiment, and the configuration of another embodiment can also be added to the configuration of a given embodiment. Further, another configuration can be added to, deleted from, or replace a part of the configuration of each of the embodiments.

The present application claims a priority based on Japanese Patent Application No. 2018-201026 filed on Oct. 25, 2018. All disclosed contents including Specification, Scope of Claims, Drawings, and Abstract of Japanese Patent Application No. 2018-201026 filed on Oct. 25, 2018 are incorporated herein by reference in their entirety.

### REFERENCE SIGNS LIST

1 suspension system, 2 compressor (pressurization device), 11 air suspension (suspension on one side), 18, 28 vehicle height sensor (vehicle height detector), 21 air suspension (suspension on another side)

1. A suspension system, comprising:
a right-side suspension and a left-side suspension interposed between a vehicle body and an axle, each of the right-side suspension and the left-side suspension being provided on at least one of a front side and a rear side so as to be capable of adjusting a vehicle height in accordance with supply and discharge of working fluid;
a supply/discharge mechanism configured to supply and discharge the working fluid to and from each of the right-side suspension and the left-side suspension; and
a vehicle height detector configured to detect or estimate the vehicle height of each of the right-side suspension and the left-side suspension,
wherein when vehicle height adjustment of each of the right-side suspension and the left-side suspension is performed through use of the supply/discharge mechanism so that a detection value of the vehicle height detector approaches a target vehicle height, a stopped vehicle height of a suspension on one side, which is one of the right-side suspension and the left-side suspension, and stops first, is determined in consideration of a vehicle height changed in accordance with a change in vehicle height of a suspension on another side after the stop.

2. The suspension system according to claim 1, wherein the stopped vehicle height of the suspension on the one side is determined based on a vehicle height change rate of the suspension on the one side and a vehicle height change rate of the suspension on the another side.

3. The suspension system according to claim 1, wherein the stopped vehicle height of the suspension on the one side is determined, at a start of the vehicle height adjustment, based on a deviation between the vehicle height of the suspension on the one side and the vehicle height of the suspension on the another side and a vehicle height change rate of the suspension on the one side and a vehicle height change rate of the suspension on the another side.

4. The suspension system according to claim 1, wherein the stopped vehicle height of the suspension on the one side is determined based on a change rate ratio between a vehicle height change rate of the suspension on the one side and a vehicle height change rate of the suspension on the another side.

5. The suspension system according to claim 1, wherein the stopped vehicle height of the suspension on the one side is determined based on a vehicle height change rate of the suspension on the one side and a vehicle height change rate of the suspension on the another side.

6. The suspension system according to claim 1, wherein the suspension on the one side moves upward still after the vehicle adjustment is finished.

7. The suspension system according to claim 1, wherein the working fluid is air.

8. The suspension system according to claim 1, wherein the suspension on the one side and the suspension on the another side are air suspensions, and the stopped vehicle height of the suspension on the one side is determined based on a difference between an internal pressure of the suspension on the one side and an internal pressure of the suspension on the another side.

9. The suspension system according to claim 2, wherein the suspension on the one side moves upward still after the vehicle adjustment is finished.

10. The suspension system according to claim 2, wherein the working fluid is air.

11. The suspension system according to claim 3, wherein the working fluid is air.
